(19) United States
(12) Patent Application Publication
(10) Pub. No.: US 2008/0251031 A1
(43) Pub. Date: Oct. 16, 2008

(54) Assembly of Pet Grooming Tool and Hair Treatment Liquid and Method of Promoting the Sale Thereof

(75) Inventors: David R. Porter, Sunset Hills, MO (US); Angela L. Porter, Sunset Hills, MO (US)

Correspondence Address: THOMPSON COBURN, LLP, ONE US BANK PLAZA, SUITE 3500, ST LOUIS, MO, 63101, US

(73) Assignee: FURminator, Inc., Fenton, MO (US)

(21) Appl. No.: 11/733,534

(22) Filed: Apr. 10, 2007

(51) Int. Cl. A01K 13/00

(52) U.S. Cl. 119/603; 119/625

(57) ABSTRACT

A product comprises packaging, a container of liquid, a pet grooming tool, and indicia. The container of liquid and the pet grooming tool are each attached to the packaging. The pet grooming tool comprises a handle portion and a pet engageable portion. The pet engageable portion comprises a plurality of teeth. The indicia indicates that the liquid is useful for cleaning and deodorizing pet hair without applying any other liquid to the hair. The indicia also indicates that the pet grooming tool is useful for removing loose hair and dirt from a pet. The indicia is viewable from outside the product.

### FIELD OF THE INVENTION

The present invention pertains to pet care. More particularly, the present invention pertains to pet grooming tools and hair treatments for furry pets such as dogs and cats.

### BACKGROUND OF THE INVENTION

The inventors hereof have developed and patented pet grooming tools such as those disclosed in U.S. Pat. Nos. 6,782,846 and 7,077,076, which are hereby incorporated herein in their entireties by reference. The inventors sell such products and also sell shampoo, conditioners, and deodorizers for pet care.

The inventors now have conceived of present invention, which provides pet owners with ability to purchase a product that combine a grooming tool with a rinse-less hair treatment liquid. The invention simplifies pet care by allowing pet owners to purchase a product that deodorizes or cleans the fur of a pet, while also removes loose hair from the pet without cutting or pulling non-loose hair from the pet.

### SUMMARY OF THE INVENTION

The present invention is directed to a product comprising a rinse-less hair treatment liquid and a grooming tool.

In one aspect of the invention, a method comprises a step of providing a product the has packaging attached to a container of liquid and to a pet grooming tool. The pet grooming tool comprises a handle portion and a pet engageable portion. The pet engageable portion comprises a plurality of teeth. The method also comprises a step of promoting the sale of the product via indicia on the product. At least a portion of the indicia indicates that the liquid is useful for cleaning hair without applying any other liquid to the hair. The portion of the indicia also indicates that the pet grooming tool is useful for removing loose hair and dirt from a pet. Still further, the portion of the indicia is viewable from outside the product.

In another aspect of the invention, a method comprises a step of providing a product that has packaging attached to a container of liquid and to a pet grooming tool. The pet grooming tool comprises a handle portion and a pet engageable portion. The pet engageable portion comprises a plurality of teeth. The method also comprises a step of promoting the sale of the product via indicia on the product. At least a portion of the indicia indicates that the liquid is useful for altering the odor of a pet without applying any other liquid to the pet. The portion of the indicia also indicates that the pet grooming tool is useful for removing loose hair from the pet. Still further, the portion of the indicia is viewable from outside the product.

In another aspect of the invention, a method comprises a step of providing a product that has packaging attached to a container of liquid and to a pet grooming tool. The pet grooming tool comprises a handle portion and a pet engageable portion. The pet engageable portion comprises a plurality of teeth. The method also comprises a step of promoting the sale of the product via indicia on the product. At least a portion of the indicia indicates that the liquid is useful for cleaning hair without applying any other liquid to the hair. The portion of the indicia also indicates that the pet grooming tool is useful for removing residue resulting from the liquid from a pet. Still further, the portion of the indicia is viewable from outside the product.

In another aspect of the invention a product comprises packaging, a container of liquid, a pet grooming tool, and indicia. The container of liquid and the pet grooming tool are each attached to the packaging. The pet grooming tool comprises a handle portion and a pet engageable portion. The pet engageable portion comprises a plurality of teeth. The indicia indicates that the liquid is useful for cleaning hair without applying any other liquid to the hair. The indicia also indicates that the pet grooming tool is useful for removing loose hair and dirt from a pet. Still further, the indicia is viewable from outside the product.

In another aspect of the invention a product comprises packaging, a container of liquid, a pet grooming tool, and indicia. The container of liquid and the pet grooming tool are attached to the packaging. The pet grooming tool comprises a handle portion and a pet engageable portion. The pet engageable portion comprises a plurality of teeth. The indicia indicates that the liquid is useful for altering the odor of a pet without applying any other liquid to the pet. The indicia also indicates that the pet grooming tool is useful for removing loose hair from the pet. Still further, the indicia is viewable from outside the product.

In yet another aspect of the invention a product comprises packaging, a container of liquid, a pet grooming tool, and indicia. The container of liquid and the pet grooming tool are attached to the packaging. The pet grooming tool comprises a handle portion and a pet engageable portion. The pet engageable portion comprising a plurality of teeth. The indicia indicates that the liquid is useful for cleaning hair without applying any other liquid to the hair. The indicia also indicates that the pet grooming tool is useful for removing residue resulting from the liquid from a pet. Still further, the indicia is viewable from outside the product.

While the principal advantages and features of the invention have been described above, a more complete and thorough understanding of the invention may be obtained by referring to the drawings and the detailed description of the preferred embodiment, which follow.

### BRIEF DESCRIPTION OF THE DRAWINGS

FIG. 1 is front view of a product in accordance with the invention.

FIG. 2 is a rear view of a product in accordance with the invention.

FIG. 3 is a perspective view of a pet grooming tool in accordance with the invention.

Reference characters in the written specification indicate corresponding items shown throughout the drawing figures.

### DETAILED DESCRIPTION OF THE PREFERRED EMBODIMENT OF THE INVENTION

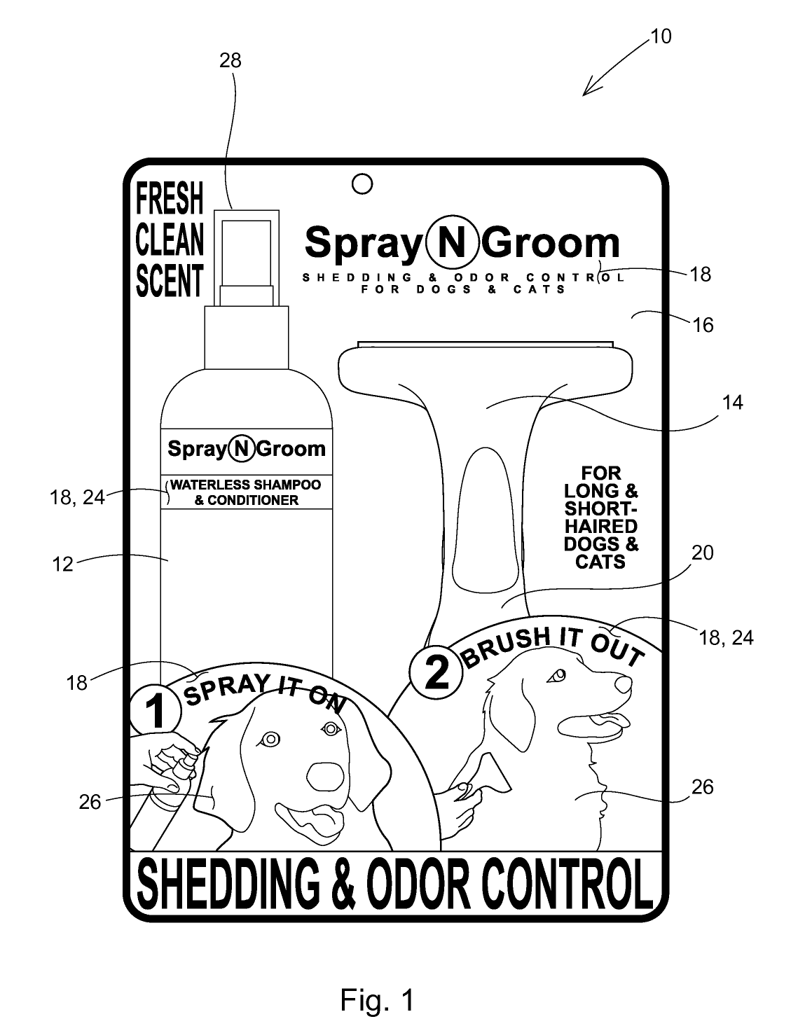

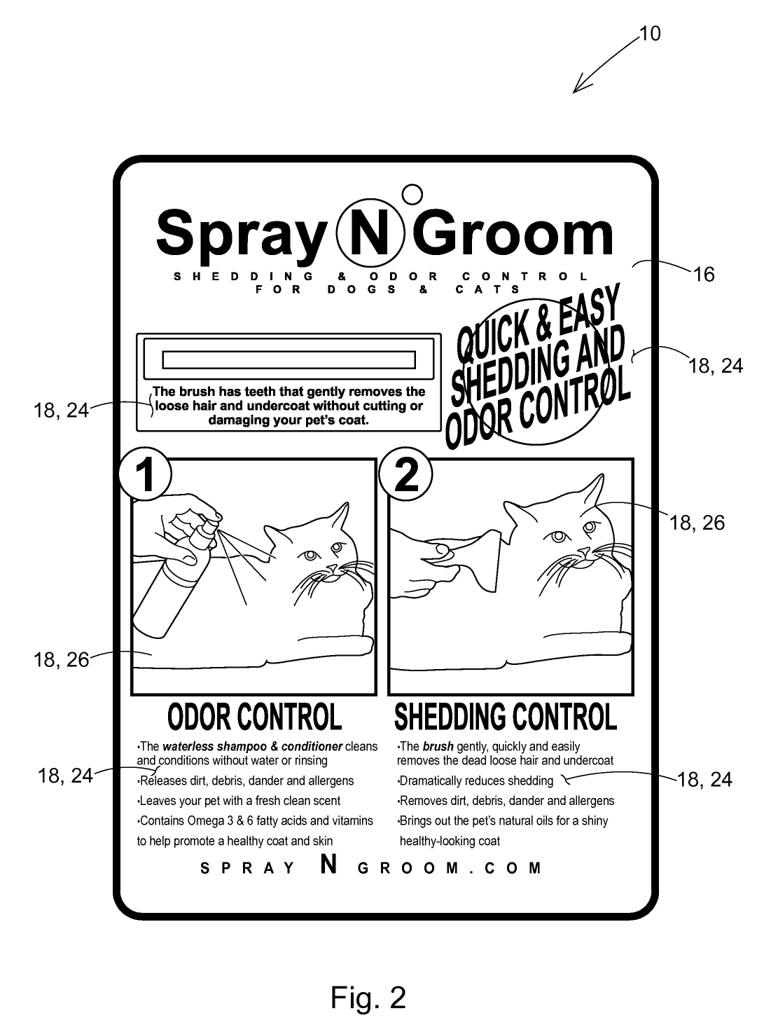

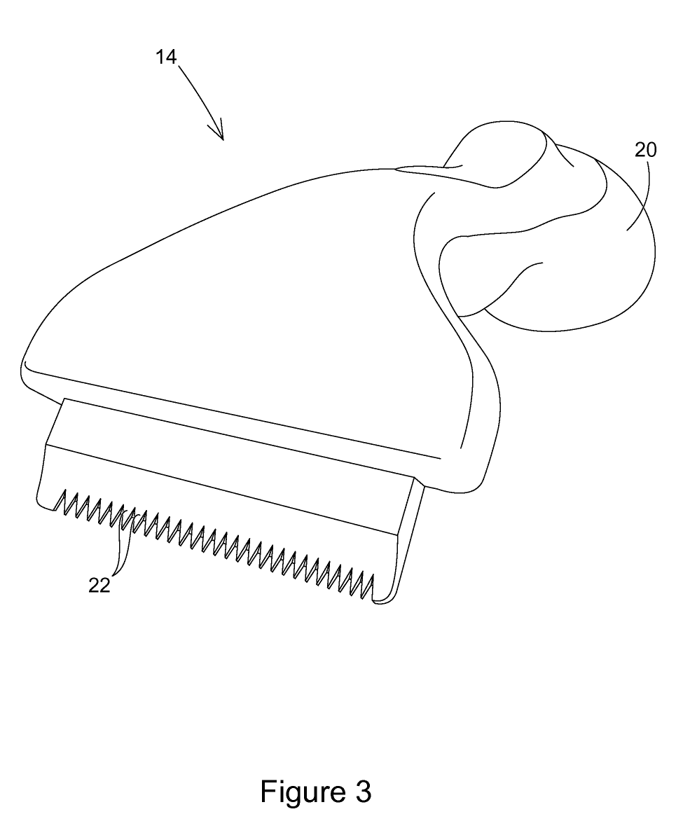

A product in accordance with the invention is shown in FIGS. 1 and 2. The product 10 comprises a container of liquid 12, a pet grooming tool 14, packaging 16, and indicia 18. The pet grooming tool 14 and the container of liquid 12 are attached to the packaging 16, preferably by thermoplastic shrink wrap. As shown in FIG. 3, The pet grooming tool 14 comprises a handle portion 20 and a plurality of teeth 22, and is adapted to remove loose hair from a furry pet without cutting or pulling non-loose hair from the pet. The container of liquid 12 preferably contains a rinse-less pet shampoo that deodorizes pet hairs, conditions hair, and that adheres to dirt and debris in the hair. Such liquids are commonly available and an example of such liquid is disclosed in U.S. Pat. No. 5,826,546, which is hereby incorporated in its entirety by reference. As is typical of such shampoos, the shampoo dries on the pet and leaves behind a powdery residue that easily removed from the pet by brushing the pet's hair.

The indicia 18 is preferably provided on the packaging 16 and the container of liquid 12. The indicia 18 also preferably comprises both text 24 and graphics 26. The indicia 18 is viewable from outside the packaging 16 and preferably indicates that liquid in the container of liquid 12 of the product 10 is useful for cleaning pet hair without applying any other liquid to the hair (i.e., that it is a rinse-less hair treatment). The indicia 18 also indicates that the pet grooming tool 14 is useful for removing residue resulting from the liquid from a pet and for pulling loose hair from the pet. Still further, the indicia 18 preferably indicates that liquid contained in the container of liquid 12 conditions and deodorizes pet hair. The indicia 18 also preferably indicates that the product 10 can be used via a two step process whereby the liquid in the container of liquid 12 is sprayed onto the hair of a pet and thereafter the pet is brushed with the pet grooming tool 14. The container of liquid 12 preferably comprises a hand operated liquid pump dispenser 28.

While the present invention has been described in reference to a specific embodiment, in light of the foregoing, it should be understood that all matter contained in the above description or shown in the accompanying drawings is intended to be interpreted as illustrative and not in a limiting sense and that various modifications and variations of the invention may be constructed without departing from the scope of the invention defined by the following claims. For example, when the rotor is used as a vacuum pump as opposed to a compressor, the exhaust ports 16 of the rotor need not discharge into any chamber of a stator and could instead discharge directly into the atmosphere. Thus, other possible variations and modifications should be appreciated.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed unless such steps must inherently be performed in such order.

What is claimed is:

1. A method comprising:
providing a product comprising packaging attached to a container of liquid and to a pet grooming tool, the pet grooming tool comprising a handle portion and a pet engageable portion, the pet engageable portion comprising a plurality of teeth; and
promoting the sale of the product via indicia on the product, at least a portion of the indicia indicating that the liquid is useful for cleaning hair without applying any other liquid to the hair, the portion of the indicia also indicating that the pet grooming tool is useful for removing loose hair and dirt from a pet, the portion of the indicia being viewable from outside the product.

2. A method in accordance with claim 1 wherein the portion of the indicia comprises text and graphics.

3. A method in accordance with claim 1 wherein the portion of the indicia is on both the packaging and the container of liquid.

4. A method in accordance with claim 1 wherein the portion of the indicia also indicates that the liquid is useful for altering the odor of a pet.

5. A method comprising:
providing a product comprising packaging attached to a container of liquid and to a pet grooming tool, the pet grooming tool comprising a handle portion and a pet engageable portion, the pet engageable portion comprising a plurality of teeth; and
promoting the sale of the product via indicia on the product, at least a portion of the indicia indicating that the liquid is useful for altering the odor of a pet without applying any other liquid to the pet, the portion of the indicia also indicating that the pet grooming tool is useful for removing loose hair from the pet, the portion of the indicia being viewable from outside the product.

6. A method in accordance with claim 5 wherein the portion of the indicia comprises text and graphics.

7. A method in accordance with claim 5 wherein the portion of the indicia is on both the packaging and the container of liquid.

8. A method in accordance with claim 5 wherein the portion of the indicia also indicates that the pet grooming tool is useful for removing dirt from a pet.

9. A method comprising:
providing a product comprising packaging attached to a container of liquid and to a pet grooming tool, the pet grooming tool comprising a handle portion and a pet engageable portion, the pet engageable portion comprising a plurality of teeth; and
promoting the sale of the product via indicia on the product, at least a portion of the indicia indicating that the liquid is useful for cleaning hair without applying any other liquid to the hair, the portion of the indicia also indicating that the pet grooming tool is useful for removing residue resulting from the liquid from a pet, the portion of the indicia being viewable from outside the product.

10. A method in accordance with claim 9 wherein the portion of the indicia comprises text and graphics.

11. A method in accordance with claim 9 wherein the portion of the indicia is on both the packaging and the container of liquid.

12. A method in accordance with claim 9 wherein the portion of the indicia also indicates that the pet grooming tool is useful for removing loose hair from a pet.

13. A product comprising:
packaging;
a container of liquid, the container of liquid being attached to the packaging;
a pet grooming tool comprising a handle portion and a pet engageable portion, the pet engageable portion comprising a plurality of teeth, the pet grooming tool being attached to the packaging; and
indicia indicating that the liquid is useful for cleaning hair without applying any other liquid to the hair, the indicia also indicating that the pet grooming tool is useful for removing loose hair and dirt from a pet, the indicia being viewable from outside the product.

14. A product in accordance with claim 13 wherein the portion of the indicia comprises text and graphics.

15. A product in accordance with claim 13 wherein the portion of the indicia is on both the packaging and the container of liquid.

16. A product in accordance with claim 13 wherein the portion of the indicia also indicates that the liquid is useful for altering the odor of a pet.

17. A product comprising:
packaging;
a container of liquid, the container of liquid being attached to the packaging;
a pet grooming tool comprising a handle portion and a pet engageable portion, the pet engageable portion comprising a plurality of teeth, the pet grooming tool being attached to the packaging; and
indicia indicating that the liquid is useful for altering the odor of a pet without applying any other liquid to the pet, the indicia also indicating that the pet grooming tool is useful for removing loose hair from the pet, the indicia being viewable from outside the product.

18. A product in accordance with claim 17 wherein the portion of the indicia comprises text and graphics.

19. A product in accordance with claim 17 wherein the portion of the indicia is on both the packaging and the container of liquid.

20. A product in accordance with claim 17 wherein the portion of the indicia also indicates that the pet grooming tool is useful for removing loose hair from a pet.

21. A product comprising:
packaging;
a container of liquid, the container of liquid being attached to the packaging;
a pet grooming tool comprising a handle portion and a pet engageable portion, the pet engageable portion comprising a plurality of teeth, the pet grooming tool being attached to the packaging; and
indicia indicating that the liquid is useful for cleaning hair without applying any other liquid to the hair, the indicia also indicating that the pet grooming tool is useful for removing residue resulting from the liquid from a pet, the indicia being viewable from outside the product.

22. A product in accordance with claim 21 wherein the portion of the indicia comprises text and graphics.

23. A method in accordance with claim 21 wherein the portion of the indicia is on both the packaging and the container of liquid.

24. A method in accordance with claim 21 wherein the indicia also indicates that the pet grooming tool is useful for removing loose hair from the pet.
